(19) United States
(12) Patent Application Publication
(10) Pub. No.: US 2013/0023452 A1
(43) Pub. Date: Jan. 24, 2013

(54) METHOD OF IMPROVING OXIDATION STABILITY OF A LUBRICATING COMPOSITION

(71) Applicants: Peter John VAN DEN BRINK, Amserdam (NL); Rafael HERRERA, Houston, TX (US); Richard Thomas DIXON, Chester (GB); Jason R. BROWN, Chester (GB); Opinder Kishan BAHN, Katy, TX (US)

(72) Inventors: Peter John VAN DEN BRINK, Amserdam (NL); Rafael HERRERA, Houston, TX (US); Richard Thomas DIXON, Chester (GB); Jason R. BROWN, Chester (GB); Opinder Kishan BAHN, Katy, TX (US)

(73) Assignee: SHELL OIL COMPANY, Houston, TX (US)

(21) Appl. No.: 13/622,867

(22) Filed: Sep. 19, 2012

Related U.S. Application Data
(60) Provisional application No. 61/538,419, filed on Sep. 23, 2011.

(51) Int. Cl. C10M 125/04; G01F 23/04; C09K 15/02

(52) U.S. Cl. 508/136; 508/150; 252/397; 33/722

(57) ABSTRACT

Methods of improving the oxidation stability of a lubricating engine oil composition comprising the step of (i) bringing the lubricating engine oil composition into contact with a solid state antioxidant. An engine and an oil filter comprising a solid state antioxidant are also disclosed. A dipstick which is coated with a solid state antioxidant is also disclosed.

### CROSS-REFERENCE TO RELATED APPLICATIONS

This application claims the benefit of U.S. Provisional Application No. 61/538,419, filed on Sep. 23, 2011.

### FIELD OF THE INVENTION

The present invention relates to a method of improving the oxidation stability of a lubricating engine oil composition. The present invention also relates to a method for extending the oil drain interval of an internal combustion engine. The present invention further relates to an engine, an oil filter and a dipstick.

### BACKGROUND OF THE INVENTION

During the combustion process in internal combustion engines, mineral and organic acidic by-products are produced mainly via oxidation. Concurrently, other acidic products may be generated by the degradation of lubricants used in internal combustion engines. Such byproducts may lead to the formation of high temperature deposits, low temperature sludge formation and corrosion of various engine parts which ultimately may lead to increased wear of lubricated engine components. Further, these byproducts may lead to an increase in a vehicle's downtime, for example by requiring more frequent oil changes than the recommended oil change interval, or dramatically shorten an engine's life.

Currently, oil soluble antioxidants are used for improving the oxidation stability of a lubricating oil composition, wherein the oil soluble antioxidants are dissolved in the lubricating oil. This is a well known approach that is applied in almost all lubricating oils for use in internal combustion engines. The disadvantage of this system is the amount of antioxidant that can be added to the oil is limited for several reasons (e.g. regulation, solubility, adverse effects of lubricity, etc.). It would therefore be desirable to provide an alternative method for improving the oxidation stability of a lubricating oil composition. It would also be desirable to extend the oil drain interval of an engine containing a lubricating oil composition.

GB-A-2453019 relates to a slow release liquid additive concentrate for use in an engine oil filter having therein at least one detergent and at least one antioxidant. The additive is said to extend the oil drain interval of an engine by retaining the basicity of the engine lubricant. However, the antioxidants disclosed in GB-A-2453019 are conventional soluble antioxidants selected from the group consisting of alkyl-substituted phenols, phenate sulphides, phosphosulfurized terpenes, sulfurized esters, aromatic amines, hindered phenols, and combinations thereof.

It has now surprisingly been found by the present inventors that if a solid state antioxidant is brought into contact with a lubricating oil composition, then improvements in the stability and lifetime of the lubricating oil composition can be achieved.

### SUMMARY OF THE INVENTION

According to the present invention there is provided a method of improving the oxidation stability of a lubricating engine oil composition comprising the step of (i) bringing the lubricating engine oil composition into contact with a solid state antioxidant.

According to a further aspect of the present invention there is provided an engine comprising a solid state antioxidant.

According to a further aspect of the present invention there is provided an oil filter comprising a solid state antioxidant.

According to yet a further aspect of the present invention there is provided a dipstick wherein the dipstick is coated with a solid state antioxidant.

According to yet a further aspect of the present invention there is provided a method of extending the oil drain interval of an engine containing a lubricating engine oil composition, wherein the method comprises the step of (i) bringing the lubricating engine oil composition into contact with a solid state antioxidant.

### DETAILED DESCRIPTION OF THE INVENTION

As used herein, the term “solid state antioxidant” means an antioxidant that is solid at room temperature and which has a high melting point, being above the temperature at which the lubricating composition is used. Preferably the melting point of the solid state antioxidant is preferably above 160° C., more preferably above 200° C. and most preferably above 250° C.

In addition, the solid state antioxidant should not dissolve or leach significant quantities in mineral oil at or below the temperature of the lubricant during use. At temperature of 100° C., preferably the solid state antioxidant should not dissolve or leach more than 0.1 gram/hour, more preferably not more than 0.05 gram/hour, and even more preferably not more than 0.01 gram/hour.

As used herein, the term “solid state antioxidant” excludes the soluble-type of antioxidants which are typically used in lubricating oil compositions and also excludes antioxidants present in systems wherein the antioxidants are slowly released in the mineral oil.

Engines that may benefit by the use of a solid state antioxidant in the present invention include, but are not limited to internal combustion engines, stationary engines, generators, diesel and/or gasoline engines, on highway and/or off highway engines, aviation engines, piston engines, marine engines, railroad engines, biodegradable fuel engines and the like. In one embodiment, the engine may be equipped with aftertreatment devices, such as exhaust gas recirculation systems, catalytic converters, diesel particulate filters, NO traps, and the like.

The present invention makes use of one or more solid state antioxidants, preferably having a relatively high internal surface area.

The solid state antioxidant can be in a granular form (pills, extrudates, balls etc.) or in the form of a structure (honeycombs, supported metal filaments, foam etc.) or in the form of powder.

As mentioned above, the solid state antioxidant preferably has a relatively high internal surface area, preferably in the range of from 0.1 m²/g to 1000 m²/g, more preferably from 0.5 m²/g to 300 m²/g, even more preferably from 1 m²/g to 300 m²/g, as measured by nitrogen physisorption according to the BET method.

In one embodiment of the present invention, the solid state antioxidant comprises silver. The silver is preferably present at a level of from 1 wt % to 40 wt %, more preferably from 5 wt % to 30 wt %, even more preferably from 10 wt % to 20 wt %, by weight of the solid state antioxidant.

In another embodiment of the present invention, the solid state antioxidant comprises phosphorus and magnesium. The phosphorus is preferably present at a level of 0.25 wt % to 4 wt %, by weight of the solid state antioxidant. The magnesium is preferably present at a level of 0.25 wt % to 4 wt %, by weight of the solid state antioxidant.

In preferred embodiments, the solid state antioxidants are present on a support material. Suitable support materials for use herein include alpha-alumina, gamma-alumina, eta-alumina, theta-alumina, silica, titania, zirconia, or mixtures thereof.

Other suitable support materials for use herein include zeolites, such as ZSM-5 (MFI), Zeolite X (FAU), Zeolite Y (FAU), Ferrierite (FER), Zeolite A (LTA), Zeolite beta (BEA), MCM-22 (MWW), and the like. In the list above, the first name is the common name and the name in brackets is the structural code according to the IZA (International Zeolite Association).

Particularly good results have been observed when the solid state antioxidant is selected from silver on an alpha-alumina support. A preferred method of preparing said silver-based solid state antioxidant is according to the preparation methods detailed in U.S. Pat. No. 4,766,105.

Good results have also been observed when the solid state antioxidant is selected from phosphorus/magnesium on ZSM-5.

The solid state antioxidant may be located anywhere within the lubrication system of the engine so long as the solid state antioxidant will come into contact with the lubricating composition on a frequent and regular basis. For example, the solid state antioxidant may be located in at least one of the oil sump, a filter, drain pan, oil bypass loop, canister, housing, reservoir, compartment of a filter, canister in a filter, canister in a bypass system, and the like. In one embodiment, the lubrication system comprises an oil filter and the oil filter includes the solid state antioxidant contained therein.

In another embodiment, the oil filter may comprise a housing, such as a sleeve or cup, that may be partitioned, for example with a non-diffusable barrier, thereby creating at least one compartment for holding the solid state antioxidant. The filter may be a desirable location to place the solid state antioxidant because the solid state antioxidant may easily be removed when the filter is removed and then replaced with a new and/or recycled solid state antioxidant.

In yet another embodiment, the solid state antioxidant may be located in another location within the lubrication system. For example, the solid state antioxidant may be located outside of an oil filter on the “dirty” side thereof or may be located outside of the oil filter on the “clean” side thereof.

In yet another embodiment of the present invention the solid state antioxidant is present in the sump. When the antioxidant is present in the sump it may be present in one or more of a variety of forms. Firstly, the solid state antioxidant may be present as a layer on the bottom of the engine casing. Secondly, the solid state antioxidant may be present as an agglomerate of granular particles. When present in granular form, it is necessary to keep the granules together, by, for example, putting them in a net which has a grain size smaller than that of the granules. The net may then be attached to the bottom of the pan.

A third way of introducing a solid state antioxidant into the sump is to use a solid state antioxidant which is monolithic in nature. As used herein, the term “monolithic” means a porous structure present in one body comprising pores or channels with openings of at least 0.1 mm which will allow a free passage towards the inner part of the structure. A non-limiting example for such a monolithic structure is the honeycomb structure that is well known for its application as catalytic converter in the exhaust gas of cars. In such system, the monolith comprises a large number of parallel oriented passages protruding through the structure from one end of the structure to the other end where the walls between the passages consist of a ceramic, metallic or polymeric material. On the inner walls between these channels a washcoat layer that may have a different composition that the walls may be present to create its antioxidant function. Alternatively, the walls themselves may comprise the material having the antioxidant function.

Other examples of a monolithic structure are a foam, a woven or kneaded structure, an openly sintered structure or randomly packed fibre structure. In such cases, the channels are more erratic in nature. Also here, the antioxidant function can be applied as a washcoat onto the inner walls of the preformed structure or the walls themselves may comprise the material having the antioxidant function. Also here the structure of the walls may consist of ceramic, metallic or polymeric material.

A fourth way of introducing a solid state antioxidant into the sump is via a dipstick. In such an embodiment, the solid state antioxidant may be present on the surface of the dipstick as a coating such that when the dipstick is dipped into the sump the solid state antioxidant is brought into contact with the lubricating oil composition.

It is also envisaged that the solid state antioxidant can be located in more than one place at the same time. For example, a first solid state antioxidant can be located in the sump, whilst a second solid state catalytic, which may be the same as or different from the first solid state antioxidant can be located on the surface of the dipstick. Hence in such a case, the lubricating composition comes into contact with solid state antioxidant both on the dipstick and in the sump.

By bringing the lubricating oil composition into contact with the solid state antioxidant, it is believed that the engine oil drain interval may be extended beyond current manufacturer's recommendations.

In one embodiment of the present invention, the oil drain interval may be extended beyond about 7,500 miles, such as beyond about 10,000 miles for normal service. The solid state antioxidant may be present in the lubrication system of the engine preferably in an amount of 0.1% by vol. or greater, more preferably 0.5% by vol. or greater, on the basis of the total volume of the lubricating oil composition present in the engine. The solid state antioxidant may be present in the lubrication system of the engine preferably in an amount of 10% by volume or less, more preferably 5% by volume or less, on the basis of the total volume of the lubricating oil composition present in the engine. An optimum level of solid state antioxidant for use herein is preferably 2% by volume, on the basis of the total volume of the lubricating oil composition present in the engine.

There is no limitation on the type of lubricating oil composition that may be used in the present invention. Lubricating oil compositions according to the present invention contain a lubricating oil as the base fluid, and are suitable for use as an engine crank case lubricant.

The total amount of base oil incorporated in the lubricating oil composition is at least 60 percent by weight, preferably in the range of from 60 to 92 percent by weight, more preferably in the range of from 75 to 90 percent by weight and most preferably in the range of from 75 to 88 percent by weight, with respect to the total weight of the lubricating oil composition.

There are no particular limitations regarding the base oil used in the lubricating oil composition, and various conventional known mineral oils and synthetic oils may be conveniently used.

The base oil used in the lubricating oil composition may conveniently comprise mixtures of one or more mineral oils and/or one or more synthetic oils.

Mineral oils include liquid petroleum oils and solvent-treated or acid-treated mineral lubricating oil of the paraffinic, naphthenic, or mixed paraffinic/naphthenic type which may be further refined by hydrofinishing processes and/or dewaxing.

Naphthenic lubricating oils have low viscosity index (VI) (generally 40-80) and a low pour point. Such lubricating oils are produced from feedstocks rich in naphthenes and low in wax content and are used mainly for lubricants in which colour and colour stability are important, and VI and oxidation stability are of secondary importance.

Paraffinic lubricating oils have higher VI (generally >95) and a high pour point. Said lubricating oils are produced from feedstocks rich in paraffins, and are used for lubricants in which VI and oxidation stability are important.

Fischer-Tropsch derived lubricating oils may be conveniently used in the lubricating oil composition, for example, the Fischer-Tropsch derived lubricating oils disclosed in EP-A-776959, EP-A-668342, WO-A-97/21788, WO-00/15736, WO-00/14188, WO-00/14187, WO-00/14183, WO-00/14179, WO-00/08115, WO-99/41332, EP-1029029, WO-01/18156 and WO-01/57166.

Synthetic processes enable molecules to be built from simpler substances or to have their structures modified to give the precise properties required.

Synthetic lubricating oils include hydrocarbon oils such as olefin oligomers (PAOs), dibasic acids esters, polyol esters, and dewaxed waxy raffinate. Synthetic hydrocarbon base oils sold by the Royal Dutch/Shell Group of Companies under the designation “XHVI” (trade mark) may be conveniently used.

Preferably, the lubricating oil is constituted from mineral oils and/or synthetic oils which contain more than 80% wt of saturates, preferably more than 90 percent by weight, as measured according to ASTM D2007.

It is further preferred that the lubricating oil contains less than 1.0 percent by weight, preferably less than 0.1 percent by weight of sulphur, calculated as elemental sulphur and measured according to ASTM D2622, ASTM D4294, ASTM D4927 or ASTM D3120.

Preferably, the viscosity index of the lubricating oil, is more than 80, more preferably more than 120, as measured according to ASTM D2270.

Preferably, the lubricating oil has a kinematic viscosity in the range of from 2 to 80 mm²/s at 100 ° C., more preferably in the range of from 3 to 70 mm²/s, most preferably in the range of from 4 to 50 mm²/s.

The total amount of phosphorus in the lubricating oil is preferably in the range of from 0.04 to 0.1 percent by weight, more preferably in the range of from 0.04 to 0.09 percent by weight and most preferably in the range of from 0.045 to 0.09 percent by weight, based on total weight of the lubricating oil.

The lubricating oil preferably has a sulphated ash content of not greater than 1.0 percent by weight, more preferably not greater than 0.75 percent by weight and most preferably not greater than 0.7 percent by weight, based on the total weight of the lubricating oil.

The lubricating oil composition preferably has a sulphur content of not greater than 1.2 percent by weight, more preferably not greater than 0.8 percent by weight and most preferably not greater than 0.2 percent by weight, based on the total weight of the lubricating oil lubricating oil composition.

The lubricating oil composition may further comprise additives such as soluble antioxidants (as opposed to solid state antioxidants described hereinabove), anti-wear additives, detergents, dispersants, friction modifiers, viscosity index improvers, pour point depressants, corrosion inhibitors, defoaming agents and seal fix or seal compatibility agents.

Soluble antioxidants that may be conveniently used include those selected from the group of aminic antioxidants and/or phenolic antioxidants.

In a preferred embodiment, said soluble antioxidants are present in an amount in the range of from 0.1 to 5.0 percent by weight, more preferably in an amount in the range of from 0.3 to 3.0 percent by weight, and most preferably in an amount of in the range of from 0.5 to 1.5 percent by weight, based on the total weight of the lubricating oil composition.

The lubricating oil composition may conveniently contain a single zinc dithiophosphate or a combination of two or more zinc dithiophosphates as anti-wear additives, the or each zinc dithiophosphate being selected from zinc dialkyl-, diaryl- or alkylaryl-dithiophosphates.

The lubricating oil composition may generally contain in the range of from 0.4 to 1.0 percent by weight of zinc dithiophosphate, based on total weight of the lubricating oil composition.

Additional or alternative anti-wear additives may be conveniently used in the lubricating oil composition of the present invention.

Suitable alternative anti-wear additives include boron-containing compounds such as borate esters, borated fatty amines, borated epoxides, alkali metal (or mixed alkali or alkaline earth metal) borates and borated overbased metal salts. Said boron-containing anti-wear additives may be conveniently added to the lubricating oil in an amount in the range of from 0.1 to 3.0 percent by weight, based on the total weight of lubricating oil composition.

Typical detergents that may be used in the lubricating oil composition include one or more salicylate and/or phenate and/or sulphonate detergents.

However, as metal organic and inorganic base salts which are used as detergents can contribute to the sulphated ash content of a lubricating oil composition, in a preferred embodiment of the present invention, the amounts of such additives are minimised.

Furthermore, in order to maintain a low sulphur level, salicylate detergents are preferred.

Thus, in a preferred embodiment, the lubricating oil composition may contain one or more salicylate detergents.

In order to maintain the total sulphated ash content of the lubricating oil composition at a level of preferably not greater than 1.0 percent by weight, more preferably at a level of not greater than 0.75 percent by weight and most preferably at a level of not greater than 0.7 percent by weight, based on the total weight of the lubricating oil composition, said detergents are preferably used in amounts in the range of 0.05 to 12.5 percent by weight, more preferably from 1.0 to 9.0 percent by weight and most preferably in the range of from 2.0 to 5.0 percent by weight, based on the total weight of the lubricating oil composition.

Furthermore, it is preferred that said detergents, independently, have a TBN (total base number) value in the range of from 10 to 500 mg.KOH/g, more preferably in the range of from 30 to 350 mg.KOH/g and most preferably in the range of from 50 to 300 mg.KOH/g, as measured by ISO 3771.

The lubricating oil compositions may additionally contain an ash-free dispersant which is preferably admixed in an amount in the range of from 5 to 15 percent by weight, based on the total weight of the lubricating oil composition.

Examples of ash-free dispersants which may be used include the polyalkenyl succinimides and polyalkenyl succininic acid esters disclosed in Japanese Patent Nos. 1367796, 1667140, 1302811 and 1743435. Preferred dispersants include borated succinimides.

Examples of viscosity index improvers which may conveniently used in the lubricating oil composition include the styrene-butadiene copolymers, styrene-isoprene stellate copolymers and the polymethacrylate copolymer and ethylene-propylene copolymers. Such viscosity index improvers may be conveniently employed in an amount in the range of from 1 to 20 percent by weight, based on the total weight of the lubricating oil composition.

Polymethacrylates may be conveniently employed in the lubricating oil compositions as effective pour point depressants.

Furthermore, compounds such as alkenyl succinic acid or ester moieties thereof, benzotriazole-based compounds and thiodiazole-based compounds may be conveniently used in the lubricating oil composition as corrosion inhibitors.

Compounds such as polysiloxanes, dimethyl polycyclohexane and polyacrylates may be conveniently used in the lubricating oil composition as defoaming agents.

Compounds which may be conveniently used in the lubricating oil composition as seal fix or seal compatibility agents include, for example, commercially available aromatic esters.

The present invention will be further understood from the following examples. Unless otherwise stated, all amounts and concentrations disclosed in the examples are based on weight of the fully formulated fuel composition.

### EXAMPLES

In order to demonstrate the benefits of the present invention bulk oxidation testing was carried out on a lubricant composition containing no solid state antioxidant (base composition) and also lubricant compositions containing various solid state anti-oxidants.

Experimental Set-up

Various lubricating oil compositions were prepared by blending base oils and additive components in the amounts as shown in Table 2 below. Comparative Example 1 was the base lubricating composition, without any solid state antioxidant. Examples 1 and 2 and Comparative Examples 3 and 4 each contained 0.5 wt % of a solid state antioxidant in addition to the base lubricating composition. The solid state antioxidants were prepared according to the preparation methods indicated below.

### Preparation of Solid State Antioxidant Used in Example 1

Example 1 contained 0.5 wt % of silver on alpha-alumina support. The solid state antioxidant contained 17.5 wt % of silver, together with small quantities of cesium, lithium, rhenium and tungsten. The solid state antioxidant was prepared according to the general preparation methods detailed in U.S. Pat. No. 4,766,105.

### Preparation of Solid State Antioxidant Used in Example 2

Example 2 contained 0.5 wt % of silver on alpha-alumina support. The solid state antioxidant contained 14.5 wt % silver together with small quantities of cesium and lithium. The solid state antioxidant was prepared according to the general preparation methods detailed in U.S. Pat. No. 4,766,105.

### Preparation of Solid State Antioxidant Used in Example 3

Example 3 contained 0.5 wt % of phosphorus/magnesium on ZSM-5 prepared by the following preparation method. 10 g of Zeolyst International CBV 2314 (ZSM-5 powder with a molar ratio of silica to alumina of 23:1) was added to 100 ml of de-ionized water and stirred for 5 minutes. To this slurry was added 0.55 g of 85% phosphoric acid over a period of a minute. The acidified slurry was stirred for 20 minutes then 0.36 g of magnesium hydroxide, Mg(OH)2 was added over a period of a minute while stirring was continued. The pH of the slurry was adjusted to between 7 and 8 by dropwise addition of aqueous ammonium hydroxide. Then the stirred slurry was heated to 45° C. for 20 minutes. The slurry was then heated to 50° C. and held at this temperature to evaporate the liquid. The resulting powder was calcined in air by heating the powder at a rate of 2° C./minute to 500° C. for 5 hours before cooling to room temperature. The powder was loaded into a sealable pouch and then pressed in a hydrostatic press at 20,000 psig for 2 minutes. The pressed material was then crushed and sized to between 60 and 170 mesh particles. Analysis of the 60-170 mesh ZSM-5 particles proved that the sample contained both Mg and P.

### Preparation of Solid State Antioxidant Used in Comparative Example 2

Comparative Example 2 contained 0.5 wt % of vanadium on theta-alumina. The theta-alumina was obtained from KataLeuna, a subsidiary of CRI, and had a pore volume of 82 ml. 7.69 g of VOSO₄ (obtained from Alrich) was dissolved in deionized water (pH 2.27). 100 g of dried theta-alumina was impregnated with the VOSO₄ solution for 2 hours, shaking occasionally. The resulting solid was dried at 120° C. for several hours, and then calcined at 900° C. for 2 hours. The compacted bulk density of the final solid state antioxidant was 0.598 g/ml and the H₂O pore volume was 0.72 ml/g. The N₂ surface area was 110m²/g. The following results were obtained for the Hg Pore:
Size Distribution at Θ: 140° as percentage of total.
Pore Width Å
F=0.667, 60K-6K 70
F=0.900,60K-ATM 208

Other Data:
Total Pore Volume, cc/g 0.693
Median Pore Diameter, Å 350

TABLE 1

| Range Å | % |
|---|---|
| <70 | 0.82 |
| 70-100 | 0.45 |
| 100-130 | 0.26 |
| 130-150 | 0.14 |
| 150-180 | 0.35 |
| 180-200 | 0.35 |
| 200-240 | 2.53 |
| 240-300 | 19.02 |
| 300-350 | 36.50 |
| 350-450 | 34.74 |
| 450-600 | 3.05 |
| 600-1000 | 1.10 |
| 1000-3000 | 0.53 |
| 3000-5000 | 0.17 |
| >5000 | 0 |

### Preparation of Solid State Antioxidant Used in Comparative Example 3

Comparative Example 3 contained 0.5 wt % of a beta zeolite catalyst commercially available from Zeolyst International of Valley Forge under the tradename CP 811E with a silica to alumina molar ratio of 75.

TABLE 2

| Component | Wt % |
|---|---|
| PAO¹ | 8.2 |
| Mineral Group I base oil² | 78.5 |
| Additive Package³ | 13.3 |
| Total: | 100 |

¹Durasyn 168 commercially available from Ineos
²A 280 Solvent Neutral base oil
³P6660 additive package, a market general technology from Infineum

Experiments were carried out in a bulk oxidation reactor which allowed oxidation behaviours of the lubricating compositions of the Examples and Comparative Examples to be studied as a function of time at various temperatures, headspace pressures, gas composition, gas flow rates, and catalyst compositions. The reactor was filled with up to 6 ml of each lubricant to be tested. The temperature of each module could be controlled from room temperature to 250° C. Gas could be fed into each cell at flow rates of up to 1.67 slpm (standard liter per minute); a flow restriction on the exhaust manifold limits the cell headspace pressure to a maximum of 50 psig. A sampling valve associated with each cell allowed a liquid handling device to withdraw aliquots from each cell for viscosity measurement.

Recorded Data

A capillary viscometer measured the viscosity of liquid samples withdrawn from the cell. After viscosity measurements had been made, aliquots were returned to the reactor to preserve the volume of oxidized liquid.

The “Time to Break (TTB)” for a lubricating composition is deemed to be the time (in hours) for the viscosity of the lubricating composition to reach more than 150% of its initial viscosity. In Table 3 below, for each of the lubricating compositions containing a solid state catalytic antioxidant, the % improvement in Time to Break compared to Comparative Example 1 (base composition) is recorded. Where the % improvement is quoted as a negative number, this means that the “Time to Break” in hours is shorter than that of Comparative Example 1.

Experimental Conditions

The data for the catalyst/lubricant testing was completed with the following set of conditions:
Temperature: 175° C.
Gas flow rate: 50 ml/min
Gas composition: Air
Back pressure: 50 psi

The results are shown in Table 3 below.

TABLE 3

| | | % Improvement in |
|---|---|---|
| Example | Solid-State Antioxidant | TTB (Time to Break) |
| Comparative | None | — |
| Example 1 | | |
| Example 1 | Silver on alpha-alumina | 125% |
| Example 2 | Silver on alpha-alumina | 125.4% |
| Example 3 | Phosphorus/magnesium on ZSM-5 | 105.3% |
| Comparative | Vanadium on theta-alumina | −82.3% |
| Example 2 | | |
| Comparative | Beta zeolite | 0.6% |
| Example 3 | | |

Discussion

Examples 1, 2 and 3 showed an improvement in the oxidation stability of the lubricating oil composition at a 95% confidence level, as measured by 125%, 125.4% and 105.3% improvement in Time to Break, respectively. By contrast, Comparative Examples 2 and 3, did not show an improvement in the oxidation stability of the lubricating oil composition, as measured by −82.3% and 0.6% improvement in Time to Break, respectively.

What is claimed is:

1. A method of improving the oxidation stability of a lubricating engine oil composition comprising the step of (i) bringing the lubricating engine oil composition into contact with solid state antioxidant.

2. A method according to claim 1 wherein the solid state antioxidant is present in the engine.

3. A method according to claim 1 wherein the solid state antioxidant is present in the oil sump.

4. A method according to claim 1 wherein the solid state antioxidant is present in an oil filter.

5. A method according to claim 1 wherein the solid state antioxidant is present on the surface of a dipstick.

6. A method according to claim 1 wherein the solid state antioxidant has a surface area of 0.1 m²/g greater.

7. A method according to claim 1 wherein the solid state antioxidant comprises silver.

8. A method according to claim 1 wherein the solid state catalytic antioxidant comprises silver on a support.

9. A method according to claim 8 wherein the support is selected from alpha- alumina, eta-alumina, gamma-alumina, theta-alumina, silica, titania.

10. A method according to claim 8 wherein the support is alpha-alumina.

11. A method according to claim 1 wherein the solid state antioxidant is phosphorus/magnesium on zeolite.

12. A method according to claim 1 wherein the solid state antioxidant is present at a level of 0.1 wt % or greater, by weight of the lubricating engine oil composition.

13. An engine comprising a solid state antioxidant.

14. An engine according to claim 13 wherein the engine is an internal combustion engine.

15. An oil filter comprising a solid state antioxidant.

16. A dipstick wherein the dipstick is coated with a solid state antioxidant.
